(19) United States
(12) Patent Application Publication
(10) Pub. No.: US 2007/0244878 A1
(43) Pub. Date: Oct. 18, 2007

(54) Virtual sports industry simulation

(76) Inventors: Corey B. Hulme, Vancouver (CA); Timothy P. Lloyd, Vancouver (CA); Yasmine J. Lynch, Walthamstow (GB); M. Andrew Ohara, Richmond (CA); Stephen J. O'Neill, Vancouver (CA); James Ray, Walthamstow (GB)

Correspondence Address: Ralph A. Dowell of DOWELL & DOWELL P.C., 2111 Eisenhower Ave, Suite 406, Alexandria, VA, 22314, US

(21) Appl. No.: 11/404,097

(22) Filed: Apr. 14, 2006

(51) Int. Cl. G06F 17/30

(52) U.S. Cl. 707/5

(57) ABSTRACT

There is disclosed a system and method for executing a multi-user virtual sports industry simulation. In an embodiment, the system comprising means for receiving a plurality of user-controllable inputs relating to each user's economic strategy, means for receiving a plurality of user-controllable inputs relating to each user's skill strategy, means for receiving a plurality of system-controlled inputs; means for accessing a plurality of system-defined rules, and a results calculator for deterministically calculating a match result as between users in dependence upon the plurality of user-controllable inputs, system-controlled inputs, and system-defined rules. The system may further comprise means for providing feedback to at least one of a user's economic strategy and skill strategy based on the calculated match result.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### FIELD OF THE INVENTION

The present invention relates generally to the field of simulations, and more specifically to virtual sports simulations.

### BACKGROUND

As access to and use of the Internet continues to increase, Internet-based multi-user simulation games are becoming more common. With certain types of simulation games, the total number of users participating may number in the hundreds, thousands, or even more. In order to attract and retain these users, it is desirable to provide a realistic simulation experience. Systems and methods for providing improved simulation experiences are needed.

### SUMMARY

The present invention provides systems and methods for a multi-user simulation of a virtual sports industry.

In an aspect, there is provided a system for executing a multi-user virtual sports industry simulation, comprising: means for receiving a plurality of user-controllable inputs relating to each user's economic strategy; means for receiving a plurality of user-controllable inputs relating to each user's skill strategy; means for receiving a plurality of system-controlled inputs; means for accessing a plurality of system-defined rules; and a results calculator for deterministically calculating a match result as between users in dependence upon the plurality of user-controllable inputs, system-controlled inputs, and system-defined rules.

In an embodiment, the system further comprises means for providing feedback to at least one of each user's economic strategy and skill strategy based on the calculated match result.

In another embodiment, a user's economic strategy comprises a payroll element.

In another embodiment, a user's economic strategy further comprises user-controllable funding for at least one of a facilities element, a staff element, a players element, an agency element, and a coach element.

In another embodiment, a user's skill strategy comprises user-controllable selections for at least one of a facilities element, a staff element, a players element, an agency element, and a coach element.

In yet another embodiment, the system further comprises a prize pool element, wherein the prize pool element is dependant upon the output of at least one match result calculated by the results calculator.

In still another embodiment, the output from the prize pool element affects at least one of a user's subsequent economic strategy and skill strategy.

In another aspect of the invention, there is provided a computer-implemented method for executing a multi-user virtual sports industry simulation, comprising: receiving a plurality of user-controllable inputs relating to each user's economic strategy; receiving a plurality of user-controllable inputs relating to each user's skill strategy; receiving a plurality of system-controlled inputs; accessing a plurality of system-defined rules; deterministically calculating a match result as between users in dependence upon the plurality of user-controllable inputs, system-controlled inputs; and system-defined rules.

In an embodiment, the method further comprises providing feedback to at least one of a user's economic strategy and skill strategy based on the calculated match result.

In another embodiment, the method further comprises including in the user's economic strategy a payroll element.

In another embodiment, the method further comprises including in the user's economic strategy user-controllable finding for at least one of a facilities element, a staff element, a players element, an agency element, and a coach element.

In another embodiment, the method further comprises including in the user's skill strategy user-controllable selections for at least one of a facilities element, a staff element, a players element, an agency element, and a coach element.

In yet another embodiment, the method further comprises including a prize pool element, wherein the prize pool element is dependant upon the output of at least one calculated match result.

In still another embodiment, the method further comprises applying the output from the prize pool element to affect at least one of a user's subsequent economic strategy and skill strategy.

In another aspect of the invention, there is provided a data processor readable medium storing data processor code that, when loaded into a data processing device, adapts the device to execute a multi-user virtual sports industry simulation, the data processor readable medium including: code for receiving a plurality of user-controllable inputs relating to each user's economic strategy; code for receiving a plurality of user-controllable inputs relating to each user's skill strategy; code for receiving a plurality of system-controlled inputs; code for accessing a plurality of system-defined rules; code for deterministically calculating a match result as between users in dependence upon the plurality of user-controllable inputs, system-controlled inputs, and system-defined rules.

In an embodiment, the data processor medium further includes code for providing feedback to at least one of a user's economic strategy and skill strategy based on the calculated match result.

In another embodiment, the data processor medium further includes code for processing a payroll element as part of a user's economic strategy.

In another embodiment, the data processor medium further includes code for processing user-controllable finding for at least one of a facilities element, a staff element, a players element, an agency element, and a coach element as part of a user's economic strategy.

In another embodiment, the data processor medium further includes code for processing user-controllable selections for at least one of a facilities element, a staff element, a players element, an agency element, and a coach element as part of a user's skill strategy.

In another embodiment, the data processor medium further includes code for processing a prize pool element dependant upon the output of at least one calculated match result.

### BRIEF DESCRIPTION OF THE DRAWINGS

In the figures which illustrate exemplary embodiments of the invention:

FIG. 1 is a schematic block diagram of a generic data processing system that may provide an operating environment for various embodiments;

FIG. 2 is a schematic block diagram of an illustrative communications network that may provide an operating environment for various other embodiments;

FIG. 3 shows a schematic block diagram of a simulation system in accordance with an embodiment;

FIGS. 4 to 6 show illustrative screen captures of a user interface in accordance with an embodiment; and

FIG. 7 shows a schematic chart of a virtual sports industry simulation in accordance with an illustrative embodiment.

### DETAILED DESCRIPTION

As noted above, the present invention relates generally to the field of simulations, and more specifically to virtual sports simulations.

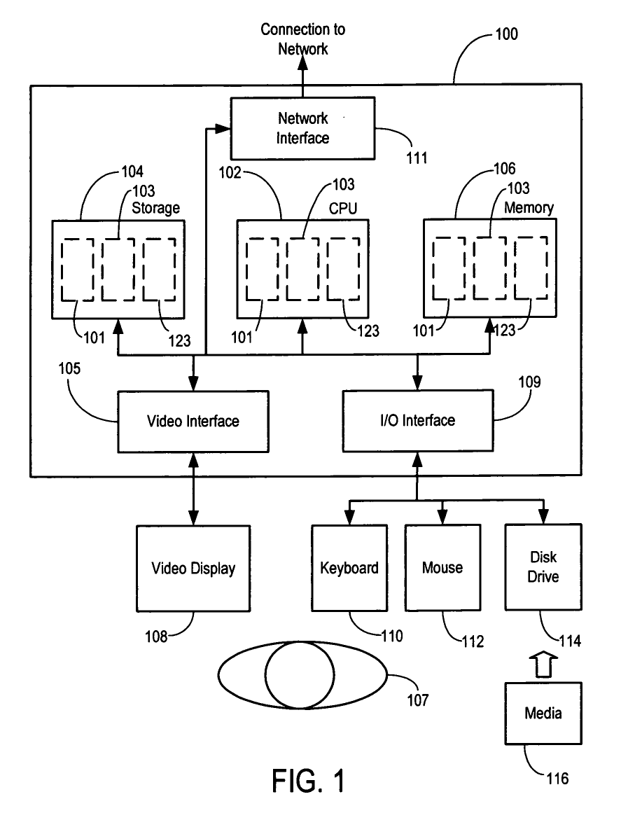

The invention may be practiced in various embodiments. A suitably configured data processing system and associated communications networks, devices, software and firmware may provide a platform for enabling one or more of the systems and methods. By way of example, FIG. 1 shows a generic data processing system 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. An operator 107 may interact with the data processing system 100 using a video display 108 connected by a video interface 105, and various input/output devices such as a keyboard 110, mouse 112, and disk drive 114 connected by an I/O interface 109. In known manner, the mouse 112 may be configured to control movement of a cursor in the video display 108, and to operate various graphical user interface (“GUTI”) controls appearing in the video display 108 with a mouse button. The disk drive 114 may be configured to accept data processing system readable media 116. The data processing system 100 may form part of a network via a network interface 111, allowing the data processing system 100 to communicate with other suitably configured data processing systems (not shown).

In an embodiment, application program 103 of data processing system 100 may be a database management system (DBMS) application. By way of example, a commercially available database management system (DBMS) such as Microsoft™ SQL™ may be used. The DBMS application program 103 may be embodied as code that may be stored in storage unit 104, and loaded into random access memory 106 and CPU 102 for processing. Data 123 associated with the DBMS application program 103 may be stored in storage unit 104 as database records and tables. The DBMS application software 103 may be run as a standalone application program on data processing system 100, or as a networked client server application program operatively connected to other data processing systems and storage servers via network interface 111. The particular configurations shown and described by way of example in this specification are not meant to be limiting.

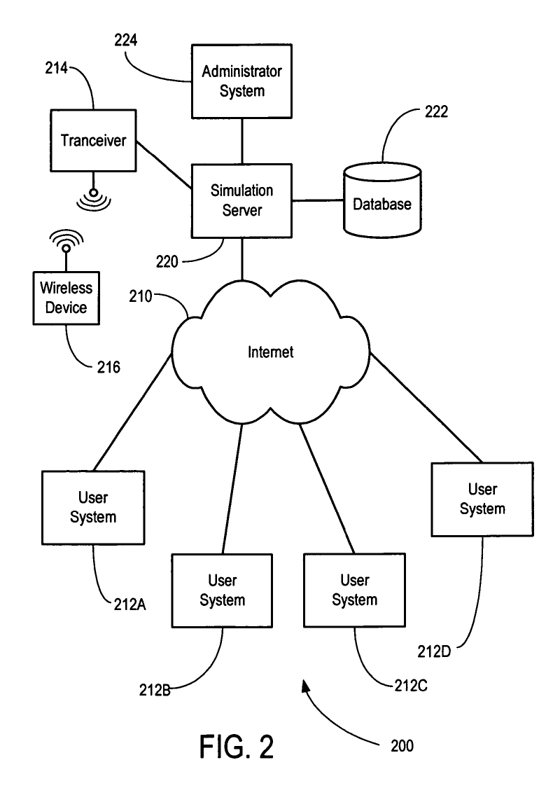

Now referring to FIG. 2, shown is a schematic block diagram of an illustrative network operating environment 200. As shown in FIG. 2, a plurality of user systems 212A-212D (such as data processing systems 100 of FIG. 1) may be operatively connected to a network 210. Network 210 may be a local area network LAN, or wide area network (WAN) such as the Internet accessible to many users over a wide geographic area. Network 210 may operatively connect the user systems 212A-212D to a simulation server 220 (which may be a suitably configured data processing system—e.g. data processing system 100 of FIG. 1) that may provide an operating environment for various systems and methods as detailed further below. Using Internet Protocol (IP), for example, simulation server 220 may be configured as an Internet web application server accessible as a URL from web browsers provided on user systems 212A-212D.

Network operating environment 200 may also incorporate a wireless communication system 214 to communicate with a user's wireless device 216. The wireless device may be Internet browser enabled to allow a wireless connection with simulation server 220.

Simulation server 220 may be connected to an external storage 222 for storing large volumes of data, and may be used by DBMS application program 103 as the main storage or as additional storage as the case may be. An administrator system 224 (e.g. a suitably configured data processing system) may be operatively connected to simulation server 220 and may be used for configuring and administering the simulation system hosted on simulation server 220.

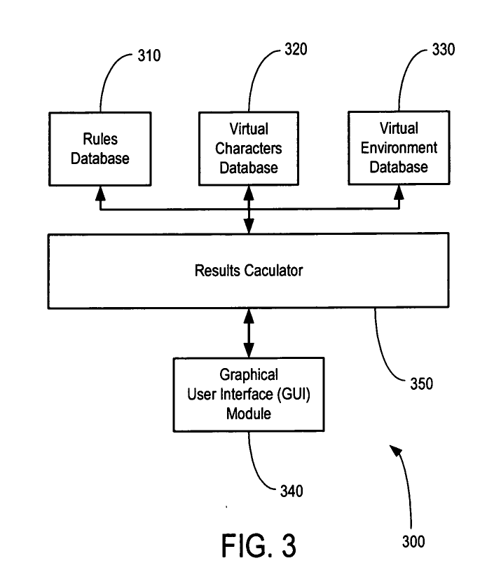

Now referring to FIG. 3, shown is a schematic block diagram of an illustrative simulation system 300 that may be hosted on the simulation server 220 of FIG. 2. As shown in FIG. 3, the simulation system 300 may include a number of components for simulating a virtual sports industry. The sports industry chosen for the purposes of this illustrative example is soccer, more commonly known outside of North America as football. However, the simulation system described herein may be suitably adapted to other sports such rugby, American football, baseball, cricket, basketball, and hockey.

In an illustrative embodiment, simulation system 300 may include a rules database 310, a virtual characters database 320, a virtual environment database 330, a graphical user interface module 340, and a results calculator 350. Rules database 310 may include rules dealing with many aspects of routine daily activities that may occur in the industry. For example, rules database 310 may include rules that cover payroll management, transfer markets, player training, scouting, and so on. Virtual characters database 320 may include detailed attributes and statistics for every virtual player 322 existing in the virtual sports industry. As will be explained further below, each virtual player 322 may be modeled using various physical, mental, and emotional attributes, and may be regulated by various rules defined in rules database 310. For example, rules database 310 may include rules that define various age ranges when players may start their careers, when their skill levels may peak, when their skill levels may deteriorate, and when they will eventually retire. Specific age ranges may be defined and may be mutually exclusive or may overlap.

Rules database 310 may be configured to run a sports industry simulation in “real-time” as defined for the particular simulation system 300 by an administrator. One of the main attractions of a virtual sports industry simulation strategy game is for users to be able see the progress and the ultimate results of their decisions. As an actual calendar year may be too long to keep the attention of some users, “real-time” may be suitably accelerated in this virtual sports industry simulation environment. For example, in an embodiment, a virtual soccer season may last 3 months such that four virtual soccer seasons may be completed in each calendar year.

In another aspect, rather than relying on any degree of random chance to reward participants with a win or loss, the results of each match between two teams may be calculated entirely deterministically. Whether a user's team wins or loses a match may be based on the user's decisions in selecting various options, and on other factors tracked by the simulation system 300 that may be static or that may change over time. The user's skill in selecting these preferences may thus be the determining factor in virtually every match. Thus, any rewards that the user may derive from the outcome of the matches would be based on a user skill rather than mere chance.

Without a random component (e.g. as introduced by a random number generator), developing a realistic simulation with seemingly random outcomes (e.g. a quantitatively weaker team beating a quantitatively stronger team) proved to be a development challenge. The inventors recognized and dealt with the problem of simulating randomness by providing a sufficiently long list of factors that may be varied. In order to maintain a sense of randomness, the actual calculations performed and the formulas used by the results calculator 350 are not made available so that users cannot readily guess what the outcome of their various choices may be. Also, as leaving the entire set of variable factors in the user's hands may make outcomes of matches too predictable, the inventors recognized that certain factors must be determined and varied by the simulation system 300 based on predefined rules (e.g. as stored in rules database 310). This is nevertheless done deterministically.

As an illustrative example, in order to simulate a single soccer match, a user may be asked to make some 10 to 100 managerial decisions. These 10 to 100 managerial decisions may be combined with some 10 to 100 distinct team factors, some of which may be controlled by the user and others of which may be determined by the simulation system 300 based on predefined rules in rules database 310. These managerial decisions and team factors may be combined with yet other factors (such as environmental factors including the stadium, spectators, weather; character attributes of players, officials, coaches, agents; match factors such as player injuries, refereeing decisions, penalty-kicks, own-goals, etc.). These other factors may be retrieved, for example, from data stored in the rules database 310, the virtual characters database 320, and/or the virtual environment database 330 to contribute to a total of some 50 to 500 user defined and system defined factors that may impact the outcome of each game. These factors may be subject to various formulations and equations to simulate the physical factors and tactics that may affect match outcomes. All of these input factors may then be processed by results calculator 350 to deterministically calculate the outcome of each match.

As an example of simulating randomness, in determining whether or not a virtual soccer player suffers injury during a particular match, an injury penalty point-scoring system may be employed. This process may integrate a number of factors to simulate the element of luck (or ‘bad luck’), which in real life matches is often considered a contributory factor in player injuries. By way of example, the factors considered may be: the player's “injury-prone” attribute, the player's and opposition players' aggression levels, the player's and opposition players' force of “tackle”, and a “bad chemistry” factor that may reflect the bad chemistry existing between players or between players and officials. These factors may be relatively static, or may change over time depending on certain occurrences in earlier matches (i.e. feedback from earlier match results).

Given the large number of factors that may be varied either by the user or the simulation system 300, it is not possible for users to predict what the outcome of the results calculator 350 for a particular match may be. For example, while a team with many quantitatively strong virtual players may win more matches over the course of a season, another team with less quantitatively strong players but higher team attributes may do as well or better during a particular match.

In a possible implementation, the sports industry simulation may be conducted on a very large scale with many more teams than would normally be found within a real professional sports league or industry. For example, a sports industry simulation may have some 16,000 to 30,000 teams that may be competing within a number of different sports leagues within the virtual sports industry. Each of these 16,000 teams may be managed by a user, and the user may select various options for factors that may determine the outcome of each match. The day-to-day managerial decisions of the user will affect the ultimate position of the user's team at the end of each virtual season.

In order to simulate many aspects of a sports industry for 16,000 to 30,000 teams, an extensive database must be created and maintained to store team information, user preferences, league schedules, archive statistics, and so on. A single virtual soccer player alone may have over 100 separate types of data stored in the virtual character database 320. For 16,000 soccer teams, approximately 240,000 virtual players are required with a corresponding virtual player database maintaining over 24 million cells of data. To manage this large number of cells, the inventors used a grouping system to help distribute stress points and manage access requirements. In prototype development, a database for 16,000 teams and 240,000 virtual players resulted in over 200 database tables amounting to over one gigabyte of stored data.

As noted above, the rules database 310 may store various rules for determining how simulation system 300 operates. As an illustrative example, the following may be the types of rules that may apply to virtual players in a match:
a) Two teams of 11 on-field players compete over two 45-minute periods of play with a maximum of 5 minutes injury time added to the end of the second period.
b) All soccer players are categorized as goalkeepers, defenders, midfielders or attackers. A player's positional categorization (natural position) is permanent.
c) Traditionally a team comprises 1 goalkeeper, 4 defenders, 4 midfielders, 2 attackers and three substitutes.
d) A player may be positioned anywhere on the field of play regardless of his natural position.
e) A player who is not positioned in accordance with his natural position will not play at optimum performance.
f) A player may be positioned anywhere on the field of play regardless of his dextrousness.
g) A player who is not positioned in accordance with his dextrousness will not play at optimum performance.
h) Any player on the pitch may score a goal.
i) Attackers are more likely to score goals than midfielders, defenders and goalkeepers.
j) Midfielders are more likely to score goals than defenders and goalkeepers.
k) Defenders are more likely to score goals than goalkeepers.
l) No player is likely to score more than four goals in one match.
m) Players sometimes accidentally score goals against their own team. No player is likely however, to score more than one own-goal during a match.
n) Players may become injured during a match.
o) Injured players play less well than un-injured players.
p) The team coach makes all decisions relating to team formation, tactics and substitutions.
q) The team coach selects one player to be team captain and one player to take dead-ball kicks.
r) An individual player's performance can be affected by their off-field behaviour.

A virtual player found in virtual character database 320 may have values for many defined attributes that may contribute to the virtual player's “pre-match power”. As an illustrative example, this value may be expressed numerically within a range between 5 and 100. The attributes that may be combined to make up a virtual player's pre-match power may include, for example:

| | | | |
|---|---|---|---|
| 1. | Total training values | (3-30) | 6 |
| 2. | Cheat attribute | (0/10) | 10 |
| 3. | Natural ability attribute | (1-25) | 16 |
| 4. | Aggression attribute | (1-10) | 7 |
| 5. | Fitness attribute | (0-10) | 5 |
| 6. | Confidence attribute | (0-10) | 8 |
| 7. | Scout bonus | (0/5) | 0 |

| | |
|---|---|
| Pre-match power total: | 57 |

Some of the above attributes may be dynamic and may change over time (e.g. the total training values may depend on how recently and how frequently a player has trained). Other attributes may be deemed to be relatively static over time (e.g. a player's tendency to cheat). It will be appreciated that each of these sub-attributes may be broken down into yet further sub-attributes.

For example, for the purposes of calculating total training values, if the player is a goalkeeper, the sub-attributes may comprise three skills such as save, gather, and distribution, each skill being ranked between 0 and 10. If the player is an outfield player (e.g. a defender, midfielder, attacker), the total training value may be a total of three other skills such as tackle, pass, and shoot, each skill again being ranked between 0 and 10. To obtain a player's total training value, the values for the individual scores may be added together.

In an embodiment, some of the player attributes will be regulated by rules database 310 based on passage of time. For example, the natural ability attribute may be a combination of a player's inherent athletic ability less a penalty for the player's age. For example, if a player has an inherent athletic ability of 20 out of a possible 25, but is past his prime playing years, a penalty may be applied to reduce the natural ability attribute by, say, 5. Various other factors may contribute to a player's pre-match power total. For example, a scout bonus may be provided depending on whether or not a scout is present.

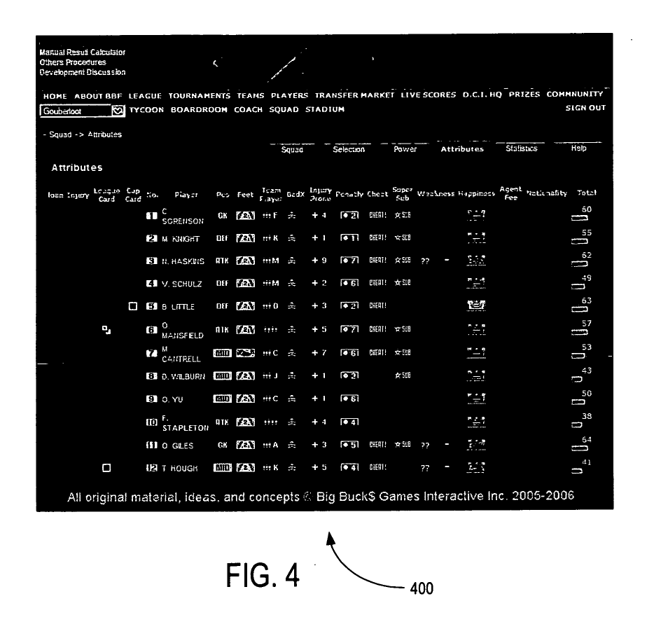

In an embodiment, these various player attributes may be presented to a user in a graphical user interface (GUI) format. By way of example, FIG. 4 shows an illustrative screen capture of a GUI screen that may provide a list of players on a team with various player attributes. As shown, these attributes may include, for example, a particular player's position, whether they can kick with both feet, the player's aggression level, whether the player is injury prone, whether the player is likely to get penalties, whether the player may cheat, and whether the player will perform better if brought into a match part way through as a substitute. Whether the player has any weaknesses and the player's state of mind may also be shown. The values for these attributes may be expressed numerically or graphically.

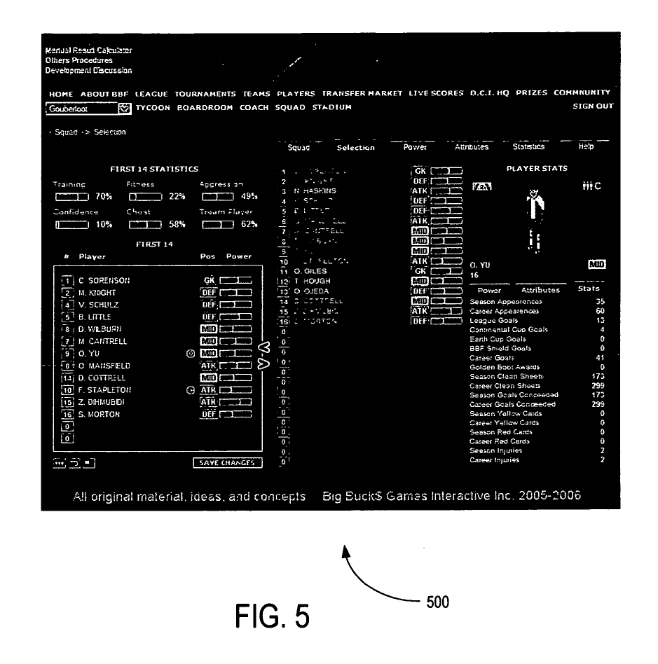

Now referring to FIG. 5, shown is an illustrative screen capture of a GUI screen that may show statistics for a particular player. Other information about a player such as the player's power and the player's attributes may be displayed by selecting the appropriate tab. With this display, a user acting as a team coach/manager may review all available information about his players. Based on this information, the user may then make various management decisions.

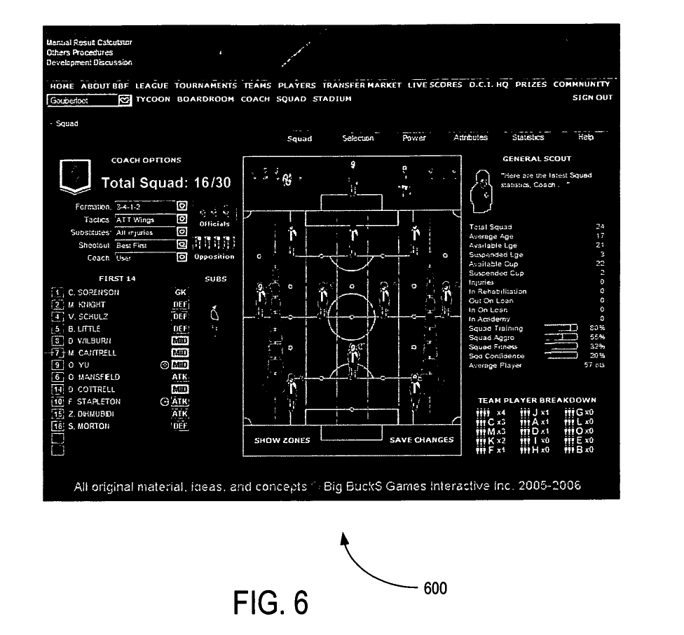

Now referring to FIG. 6, shown is an illustrative screen capture of a GUI screen that shows a soccer field. The soccer field may allow the user acting as the team coach/manager may place his players in various positions on the field, namely the positions for the goalkeeper, defenders, midfielders and attackers. The user's selection of players and placement of those players on the field will affect the calculations performed by the results calculator 350 when the team is matched up against another team similarly selected and position by another user. It will be appreciated; therefore, that the user's selection of various options may directly affect the calculations performed by results calculator 350 and the outcome of the match.

In an embodiment, the simulation system 300 may initiate decisions to be made by the user between scheduled matches. For example, a user may find himself on the receiving end of a text message or email from a (virtual) member of his staff, or an athlete belonging to his virtual soccer Club. By way of illustration, the content of any such communication may be related to an on-field incident that occurred that particular day at the soccer Club, or it may concern perhaps a financial deal being organized or proposed by a rival Club manager. This interactive feature may be further extended by the ability of the virtual staff to acknowledge and act upon the user's responses based on predetermined rules stored in rules database 310. This in turn enables the user to conduct business “in transit” using any of the many available electronic communications methods and devices.

In an embodiment, by converting and combining detailed post-result analysis and system generated descriptive text, a match with minute-by-minute text commentaries of all matches may be “broadcast live”. For example, a full match commentary may run anywhere from 120 minutes to 161 minutes in length and, depending on the evolution of the match (match-play only, penalty shootout, riot, etc.), may comprise some or all of the following elements in order:

Match-play:

| | | |
|---|---|---|
| 1. | Pre-Match Build-up | (5 mins: 1-5) |
| 2. | First-Half Match Commentary | (45 mins: 6-50) |
| 3. | Advertising Break | (15 mins: 51-65) |
| 4. | Second-Half Match Commentary | (50 mins: 66-115) |
| 5. | Full-Time Result (Result #1) | (5 mins: 116-120) |

Potential end point else:

| | | |
|---|---|---|
| 6. | Penalty Shootout (if applicable) | (10-20 mins: 121-130/140) |
| 7. | Final Result (if Penalty Shootout | (5 mins: 131/141-135/145) |
| | occurred) | |

Potential end point else:

| | | |
|---|---|---|
| 8. | Riot Commentary (if applicable) | (5 mins: 136/146-140/150) |
| 9. | Final Result (if riot occurred) | (10 mins: 141/151-150/160) |

This live commentary may be provided over an actual period of 120 to 161 minutes, but the simulation system 300 may otherwise run at the accelerated pace selected by the administrator.

Based on the system described above, it will be appreciated that the most successful users are most likely to be those who develop an intelligent strategic approach to playing the game. In order to simulate real world sports industries, the inventors have incorporated both an economics-orientated strategy (Economic Strategy) and a skill-orientated strategy (Skill Strategy), where “skill” may constitute knowledgeable and astute approach to tactical considerations as they relate to sporting matters. Thus, game-play provisions, if and when selected and utilised, may be configured to have economic as well as skill-related consequences.

For example, many of the provisions may only be utilised subject to a tariff of fees applicable in respect of those provisions. As well, utilisation of those provisions may increase the user's ability to develop his/her Skill Strategy, above and beyond the capabilities of users choosing not to apply an advanced Economic Strategy. The application of such an Economic Strategy may result therefore, in increased performance, which in turn may generate greater rewards for the user.

A further example of emphasis placed on the economics-related elements of game-play is the direct correlation between a virtual player's simulated sporting ability and the player's monetary or market value. The value of a user's virtual assets may decrease or increase based on the performance of his/her team and the players. For example, badly performing players' on-field performance may suffer as a result of simulated demoralisation, and players who perform well on-field may benefit subsequently from heightened performance as a consequence of an increased level of confidence. This type of feedback applied from the results of previous matches may result in clubs achieving a string of wins or losses that may not otherwise arise from mere simulated chance, or if the result of each match is calculated without any historical factors.

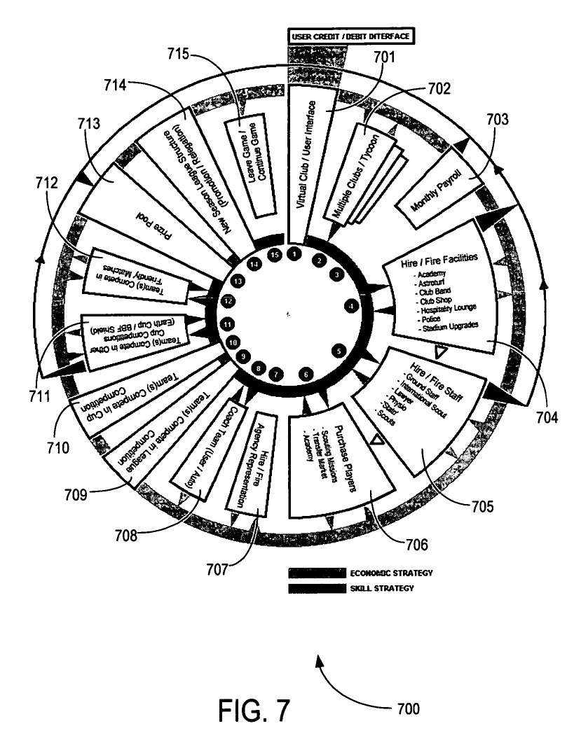

Now referring to FIG. 7, shown is a schematic chart 700 of the virtual sports industry simulation in accordance with an illustrative embodiment. Chart 700 emphasizes the dual-strategic nature of the present game model, and how the Economic Strategy and Skill Strategy may interact in a technical sense at various points in the game-play cycle.

Referring to FIG. 7, the first element 701 is the starting point for a game user. To join the game, all users must sign up to manage a football Club. Every action taken thereon by the game user can be categorised as being part of either a Skill Strategy or an Economic Strategy. These two separate strategies are labelled and shown on chart 700 as shaded circles.

Also shown at the top of chart 700 is a User Credit/Debit Interface. This interface may provide an indication that finds used to operate the game can be credited or debited from or to a third party bank or other financial entity via the user's Club account.

In an embodiment, the virtual sports industry simulation may include Clubs that are divided between two continental leagues—for example a Euro league and a “Rest of the World” league. Each continental league may be sub-divided into Federations comprising of, say, 500 Clubs and 50 Divisions, with each Division comprising of 10 Clubs. The Countries or territories that make up both the Euro zone and the Rest of the World zone may be clearly defined beforehand. The number of Federations operating at any one time may depend on the world-wide playership of the virtual sports simulation system as a whole.

As shown at element 702, a user may operate multiple Clubs as a “Tycoon”. Becoming a Tycoon may impact a user's Economic Strategy and Skill Strategy. For example, the Economic Strategy may be directly affected because of the costs involved in running multiple Clubs. This is shown by an arrow pointing inwards to a multiple Clubs element 702 (indicating the user's forethought or consideration of investing finds into multiple Clubs), and also by an arrow pointing outwards from the multiple Clubs element 702 showing the financial consequence of managing multiple Clubs. Multiple Club management affects the user's Skill Strategy because additional planning is required to effectively manage multiple Clubs.

In an embodiment, the virtual sports industry simulation may include a periodic (e.g. monthly) payroll element 703. Payroll element 703 may process monthly payroll fees which may be an integral part of the virtual sports industry simulation. The fees are payable per Club, therefore multiple Club owners, i.e. Tycoons, are liable for multiple account fees. Payroll fees may be made compulsory for all users and Clubs. This is indicated on the flow chart by the payroll element 703's direct interface with the Economic Strategy. The monthly payroll element does not directly affect the Skill Strategy.

The monthly payroll fees may be a direct contributory factor of the game's prize-money system. This is reflected on the chart 700 by a black arrow leading to an outer concentric indicator that terminates at the prize pool element 713. Payroll fees may be made up of charges relating to the various compulsory and optional game components. These components may include, for example, playing staff payroll, non-playing staff payroll, stadium costs and optional upgrades.

In an embodiment, chart 700 may include a facilities element 704. Optional facility upgrades may be purchased and these purchases may impact both the user's Economic Strategy and Skill Strategy. This is shown on chart 700 by arrows from both strategic tracks pointing inwardly to the facilities element 704 (indicating the user's forethought or consideration of investing funds into facilities to increase tactical capability) and also by arrows pointing out of the facilities element 704 showing the financial consequence (i.e. account debit) and skill consequence (i.e. increased tactical capability) of acquiring the upgrade(s).

Facility upgrade fees may also be a direct contributory factor of the game's prize-money system. This is shown on chart 700 by a black arrow leading to an outer circle indicator that terminates at the prize pool element 713. Some facilities may enable additional specialist staff to be hired by the user for the benefit of his/her Club. This is indicated on chart 700 by an arrow emanating from the facilities element 704 and pointing toward the staff element 705.

The types of facility upgrades available for hire may include, for example, a Club Academy that may award a series of scholarships to obtain custom-trained youth players. Installing an advanced playing field may afford a Club greater advantage at all home matches. Only visiting teams which themselves have the advanced playing field installed at their home stadium may be able to neutralise the home team's advantage and thus compete on a level playing field. Various other options such as a Club band, Club shop, hospitality lounge, police, and other stadium upgrades may be available.

In an embodiment, chart 700 may include staff element 705 that may offer specialist staff available for hire to improve a Club's all round performance. ‘Specialist staff’ upgrades and associated fees may be optional for all users, and the pursuit of any specialist staff upgrade options may impact both the user's Economic Strategy and Skill Strategy. This is shown on chart 700 by arrows from both strategic tracks in to the staff element 705 (indicating the user's forethought or consideration of investing funds into staffing to increase tactical capability) and also by arrows pointing outwards from the staff element 705 showing the financial consequence (i.e. account debit) and skill consequence (i.e. increased tactical capability) of acquiring the additional specialist staff. Staff fees may also be a direct contributory factor of the game's prize-money system. This is shown on chart 700 by an arrow leading to an outer concentric indicator that terminates at the prize pool element 713.

In an embodiment, hiring certain specialist staff may enable the user to purchase players via additional/alternative means. This is indicated on chart 700 by an arrow emanating from the staff element 705 and pointing toward the players element 706. The specialist staff available for hire may include, for example, a goalkeeping scout, a defence scout, a midfield scout, an attack scout, and an international scout. The specialist staff may further include a physiotherapist, ground staff, an independent analyst and statistician, and a lawyer.

In an embodiment, chart 700 may further include players element 706, which may allow users to strengthen their team's squad by purchasing additional players. Players may be purchased, for example, through scouting missions, transfer deals, and academy scholarships. Purchasing additional players impacts both the user's Economic Strategy and Skill Strategy. This is shown on chart 700 by arrows from both strategic tracks pointing inward to the players element 706 (indicating the user's forethought or consideration of investing funds in player purchases to increase tactical capability) and also by arrows pointing out of the players element 706, showing the financial consequence (i.e. account debit) and skill consequence (i.e. increased tactical capability) of acquiring the additional playing staff.

Still referring to FIG. 7, chart 700 may further include an agency element 707. All Club managers have the option to become (via an alter ego) the de facto agent of any player without current independent agent representation. Advantages to be gained by representing a player as an agent may include, for example, not having to pay agent fees for players that play for the Club manager/agent's own team, and being rewarded by third party transfer deals involving players represented by the Club manager as an agent.

Becoming an agent impacts the user's Economic Strategy. This is shown by an arrow pointing inwards to the agency element 707 (indicating the user's forethought or consideration of investing funds into player agency representation) and also by an arrow pointing outwards from the agency element 707 showing the financial consequence (account credit/debit) of becoming a player agent.

Chart 700 may further include a coach element 708 which allows a user to participate as a coach. Coaching a team impacts the user's Economic Strategy via the user's Skill Strategy. This is shown by an arrow from the Skill Strategy track pointing inwardly to the coach element 708 (indicating the user's forethought and skill in coaching the team) and also by an arrow pointing outwardly from the coach element 708 and back inwardly to the Skill Strategy (indicating the success/failure consequences of the user's Skill Strategy).

Chart 700 also shows an arrow pointing outwardly from the coach team element 708 and inwardly to the Economic Strategy track, showing the financial consequence, if any, of the user's coaching Skill Strategy. Elements of coaching a team may include numerous factors, including positioning various team players, training players, signing players, transferring players, and so on. By way of example, every Club may have the capability to train its players in a training session. Training sessions may be conducted between competitive fixture or games. The training capability of a Club may be dynamic and may respond to the on-field performance of the team. For example, a team that performs well in a competitive fixture will earn more training credits than a team that performs badly, and will therefore benefit from a more intense training regime. Teams that employ specialist scouts may also have greater flexibility in targeting specific areas of player performance that is in need of attention during these training sessions.

In an embodiment, in order to stick to the structure of scheduled fixtures, all teams require the ability to operate and compete whether managed independently by a user-client or not. Therefore, in the absence of coaching by a user, an automatic coaching mode may be built in. Several elements of artificial intelligence may be integrated to perform certain functions that would conventionally be determined and initiated by human intellect. For example, the team selection required for each fixture may be performed automatically instead of manually by a user. The automated team selection programming may be configured to adhere to a coherent and realistic team selection policy. This automatic team selection may be complemented by automatic substitutions during a match, and automatic training between matches.

Still referring to FIG. 7, chart 700 may further include a league competition element 709 in which teams may compete in regular league competition. For example, every Club may be scheduled to compete in a league division of ten teams, with each team playing all of the other teams twice. This would result in each team competing in 18 league fixtures during a season. Competing in any competitive fixture tests the user's Economic Strategy and Skill Strategy with those of another user, and the post-match results of each fixture affect the direction, focus and success of these strategies for each user. The requirement to compete in all league fixtures is shown on chart 700 by the league competition element 709's direct interface with both the Economic Strategy and the Skill Strategy.

Chart 700 may further include a cup competition element 710 in which teams may compete in a cup competition each season. The identity of the competition entered (e.g. either the “Euro cup” or the “Rest of the World cup”) depends on which of the two continental leagues is home to the relevant Club. Each continental cup competition pits all 500 teams within each Federation against one another to determine the Federation Champions. The competition is held every season with cash prizes awarded to the winners, runners-up & losing semi-finalists in each Federation. A “Gold Boot” cash prize may also be awarded to each Federation's top cup goal-scorer. By way of example, each tournament may comprise of six rounds, a quarter and semi finals phase, and a Cup final. Competing in any competitive fixture test's the user's Economic Strategy and Skill Strategy against those of another user, and the post-match results of each fixture may affect the direction, focus and success of both strategies for both users. The requirement to compete in a continental cup competition is shown on chart 700 by the cup competition element 710's direct interface with both the Economic Strategy and the Skill Strategy.

In an embodiment, chart 700 may further include an optional cup competition element 712 in which teams may voluntarily compete in other cup competitions. Entering an additional pay-to-enter cup competition impacts both the user's Economic Strategy and Skill Strategy. This is shown on chart 700 by arrows from both strategic tracks pointing inwards to the other cup competition element (indicating the user's forethought or consideration of investing funds in entry fees and tactical resources to the other competition/s) and also by arrows pointing outwardly from the optional cup competition element 712 showing the financial consequence (i.e. entry fees/financial reward) and skill consequence (i.e. depleted or increased tactical capability) of entering the additional competition(s). Voluntary cup competition entry fees are also a direct contributory factor of the game's prize-money system. This is shown on chart 700 by a black arrow leading to an outer concentric indicator that terminates at the prize pool element 713.

In an embodiment, chart 700 may include a friendly matches element 712, in which teams may voluntarily engage in a fixture with another Club on a friendly basis (meaning non-competitive and of no consequence to any major competition). All friendly fixtures may be subject to a small entry fee, with the victorious team gaining a small financial reward derivative of the combined entry fees. Competing in a friendly fixture impacts both the user's Economic Strategy and Skill Strategy. This is shown on chart 700 by arrows from both strategic tracks pointing inwardly to the friendly matches element 712 (indicating the user's forethought or consideration of investing finds in entry fees and tactical resources to the fixture) and also by arrows pointing outwardly from the friendly matches element 712 showing the financial consequence (i.e. entry fees/financial reward) and skill consequence (i.e. depleted or increased tactical capability) of competing in the ‘friendly’ fixture.

As previously noted, chart 700 also shows a prize pool element 713, which may include prize money that may be paid out in dependence upon the match results of various fixtures. Receiving or not receiving prize-money at the end of each season may impact both the user's Economic Strategy and Skill Strategy. This is shown on chart 700 by the prize pool element 713's direct interface with both the Economic Strategy and the Skill Strategy. Economic Strategy is affected because of the ability of the user to profit from competitive success, and either withdraw those profits from the game or re-invest the profits back in to the team to fund tactical expansion, thus affecting Skill Strategy. In an illustrative prize pool structure, every Federation may have a unique total payroll income each season. The total payroll incomes from all Federation (less a fee for operating the virtual sports industry simulation) may be combined to form a total global prize pool. The total global prize pool amount is divided by the quantity of Federations to calculate the global Federation prize pool amount. This is the amount that is re-distributed to each Federation to form the Federation's prize pool. Each federation's prize pool (i.e. the global Federation prize pool) may be split into a number of categories of prize types. Each category may be allocated a percentage of the federation prize pool.

In an embodiment, chart 700 may include a new season league structure element 714, in which teams may be re-ordered according to either promotion/relegation rules (e.g. applying only to the top 100 teams in each Federation) or a team's new-season ranking (e.g. applying to the remaining 400 teams in all other divisions in the same Federation). A team's rank may be determined by a number of factors dependant upon the progress made and results achieved in any of the compulsory league and cup matches. If necessary, tie-break rules may be employed to re-rank teams who after initial re-ranking procedures share the same re-ranking. The requirement of each team to submit to the process of close season re-ranking is shown on chart 700 by the new season restructure element 714's direct interface with both the Economic Strategy and the Skill Strategy.

Finally, chart 700 may include a leave game/continue game element 715 in which a user may decide to leave the virtual sports industry simulation. In an embodiment, the user may decide to leave the virtual sports industry simulation at any point in the season cycle by simply closing his/her account. Prior to doing so, the user may wish to recoup any investment he/she may have made by selling some or all of their virtual assets to other continuing game users. A decision to leave the game affects a user's Economic Strategy and this is shown on chart 700 by an arrow pointing inwards to the leave game/continue game element 715.

While various embodiments have been described, it will be appreciated that various changes and modifications may be made. More generally, the scope of the invention is defined by the following claims.

What is claimed is:

1. A system for executing a multi-user virtual sports industry simulation, comprising:
means for receiving a plurality of user-controllable inputs relating to each user's economic strategy;
means for receiving a plurality of user-controllable inputs relating to each user's skill strategy;
means for receiving a plurality of system-controlled inputs;
means for accessing a plurality of system-defined rules;
a results calculator for deterministically calculating a match result as between users in dependence upon the plurality of user-controllable inputs, system-controlled inputs, and system-defined rules.

2. The system of claim 1, further comprising means for providing feedback to at least one of a user's economic strategy and skill strategy based on the calculated match result.

3. The system of claim 2, wherein a user's economic strategy comprises a payroll element.

4. The system claim 3, wherein a user's economic strategy further comprises user-controllable funding for at least one of a facilities element, a staff element, a players element, an agency element, and a coach element.

5. The system of claim 4, wherein a user's skill strategy comprises user-controllable selections for at least one of a facilities element, a staff element, a players element, an agency element, and a coach element.

6. The system of claim 5, further comprising a prize pool element, wherein the prize pool element is dependant upon the output of at least one match result calculated by the results calculator.

7. The system of claim 6, wherein the output from the prize pool element affects at least one of a user's subsequent economic strategy and skill strategy.

8. A computer-implemented method for executing a multi-user virtual sports industry simulation, comprising:
receiving a plurality of user-controllable inputs relating to each user's economic strategy;
receiving a plurality of user-controllable inputs relating to each user's skill strategy;
receiving a plurality of system-controlled inputs;
accessing a plurality of system-defined rules;
deterministically calculating a match result in dependence upon the plurality of user-controllable inputs, system-controlled inputs, and system-defined rules.

9. The method of claim 8, further comprising providing feedback to at least one of a user's economic strategy and skill strategy based on the calculated match result.

10. The method of claim 9, further comprising including in a user's economic strategy a payroll element.

11. The method of claim 10, further comprising including in a user's economic strategy user-controllable finding for at least one of a facilities element, a staff element, a players element, an agency element, and a coach element.

12. The method of claim 11, further comprising including in a user's skill strategy user-controllable selections for at least one of a facilities element, a staff element, a players element, an agency element, and a coach element.

13. The method of claim 12, further comprising including a prize pool element, wherein the prize pool element is dependant upon the output of at least one calculated match result.

14. The method of claim 13, further comprising applying the output from the prize pool element to affect at least one of a user's subsequent economic strategy and skill strategy.

15. A data processor readable medium storing data processor code that, when loaded into a data processing device, adapts the device to execute a multi-user virtual sports industry simulation, the data processor readable medium including:
code for receiving a plurality of user-controllable inputs relating to each user's economic strategy;
code for receiving a plurality of user-controllable inputs relating to each user's skill strategy;
code for receiving a plurality of system-controlled inputs;
code for accessing a plurality of system-defined rules;
code for deterministically calculating a match result as between users in dependence upon the plurality of user-controllable inputs, system-controlled inputs, and system-defined rules.

16. The data processor readable medium of claim 15, further including code for providing feedback to at least one of a user's economic strategy and skill strategy based on the calculated match result.

17. The data processor readable medium of claim 16, further including code for processing a payroll element as part of a user's economic strategy.

18. The data processor readable medium of claim 17, further including code for processing user-controllable finding for at least one of a facilities element, a staff element, a players element, an agency element, and a coach element as part of a user's economic strategy.

19. The data processor readable medium of claim 18, further including code for processing user-controllable selections for at least one of a facilities element, a staff element, a players element, an agency element, and a coach element as part of a user's skill strategy.

20. The data processor readable medium of claim 19, further including code for processing a prize pool element dependant upon the output of at least one calculated match result.
